(19) United States
(12) Patent Application Publication
(10) Pub. No.: US 2026/0352542 A1
(43) Pub. Date: Nov. 5, 2026

(54) METHOD AND APPARATUS FOR COORDINATED SERVICE RECOVERY IN WIRELESS NETWORK

(71) Applicant: Samsung Electronics Co., Ltd., Suwon-si, Gyeonggi-do (KR)

(72) Inventors: Ashutosh KAUSHIK, Bangalore (IN); Deepanshu GAUTAM, Bangalore (IN); Erik GUTTMAN, Staines (GB)

(21) Appl. No.: 19/124,675

(22) PCT Filed: Oct. 25, 2023
(86) PCT No.: PCT/KR2023/016603

§ 371 Date: Apr. 25, 2025

(30) Foreign Application Priority Data
Oct. 25, 2022 (IN) 202241060835
Jul. 21, 2023 (IN) 2022 41060835

(51) Int. Cl. H04L 41/0654; H04L 41/50

(52) U.S. Cl. CPC H04L 41/0654; H04L 41/5032

(57) ABSTRACT

The disclosure relates to a 5G or 6G communication system for supporting a higher data transmission rate. Embodiments herein disclose a mobile network operation (MNO) entity for coordinated service recovery in a wireless communication system, the MNO entity comprising: a transceiver; and at least one processor coupled to the transceiver and configured to: receive, from a distribution system operator (DSO) entity, a first create managed object instance (MOI) request for creating an information object class (IOC), wherein the create MOI request comprises a plurality of information attributes for outage and rapid recovery, create the IOC for the outage and rapid recovery of the DSO entity based on the plurality of information attributes received from the DSO entity, and transmit, to the DSO entity, a first create MOI response after creation of the IOC.

### CROSS-REFERENCE TO RELATED APPLICATION(S)

This application is a U.S. National Stage application under 35 U.S.C. § 371 of an International application number PCT/KR2023/016603, filed on Oct. 25, 2023, which is based on and claims priority of an Indian Provisional patent application No. 202241060835, filed on Oct. 25, 2022, in the Indian Patent Office, and of an Indian Complete patent application No. 202241060835, filed on Jul. 21, 2023, in the Indian Patent Office, the disclosure of each of which is incorporated by reference herein in its entirety.

### TECHNICAL FIELD

The present disclosure relates to the field of communication technologies. Particularly, but not exclusively, the present disclosure relates to method and apparatus for coordinated service recovery.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, an energy utility provider as a distribution system operator (DSO) station is a natural or legal person who is responsible for operating, ensuring the maintenance of and, if necessary, developing a distribution system in a given area and, where applicable, its interconnections with other systems, and for ensuring a long-term ability of the distribution system to meet reasonable demands for the distribution of electricity.

The delivery of electrical energy must occur with extreme levels of availability. It is crucial in a domain, for regulatory, business and public health and safety requirements. To achieve reliable availability, a range of ‘smart energy services’ is employed by an energy system. The smart energy services, largely standardized by Institute of Electrical and Electronics Engineers (IEEE) and International Electrotechnical Commission (IEC), require communication. As greater degrees of efficiency, resiliency, responsiveness and other capabilities are sought in the generation and delivery of electricity, more and more communications services are required by an electrical energy sector. To the extent that the third generation partnership project (3GPP) communication system can provide services that meet the needs of the electrical energy sector, telecommunications will be an increasingly important part of a technical ecosystem by which electricity is delivered.

Moreover, a mobile telecommunications network require energy, so may also suffer a communications service outage when the DSO station's energy supply system goes faulty. There is clearly a mutual interest in coordination between Mobile Network Operation (MNO) telecommunications and DSO's energy service operations to achieve rapid recovery of the energy service outage. This is not only true for a MNO device, who benefits from the availability of supplied power, but also for the energy utility the service provider who needs a mobile telecommunication service to restore and maintain an operation of its grid.

Currently, disaster recovery plans are ‘static’ and data exchanged is not standards based. The energy utility provider (e.g., DSO station) knows when and where outage has occurred and when telecommunication services are critically important for the recovery. The MNO device knows their uninterruptable power supply resources and the possibility of utilizing telecommunication services to enable utility's energy system rapid recovery via the smart energy services such as for example supervisory control and data acquisition (SCADA). However, there is no standardized mechanism to share all the information between the DSO station and MNO device to enable efficient usage of the smart energy services for the service recovery. The energy utility provider (e.g., DSO station or the like) can restore energy distribution services without smart energy services, but the utility provider requires substantially longer time as it often requires manual intervention by a technician who must travel to energy distribution substations to restore the service.

So, there is a requirement of a coordinated service recovery in the network performance management. Thus, it is desired to address the above mentioned disadvantages or other shortcomings or at least provide a useful alternative.

### DISCLOSURE

### Technical Solution

The principal object of the embodiments herein is to perform a coordinated service recovery in network performance management. The coordinated service recovery in the network performance management is ensured by performing mutual exchange of information between a third party energy utility provider (e.g., DSO station or the like) and a MNO device using standardized interfaces exposed by a Third Generation Partnership Project (3GPP) network management system for rapid recovery of utility's energy service outage and subsequent fallback by the MNO device from its uninterrupted power supply (UPS) to utility's energy supply for MNO device communications service/network operations.

Further, the DSO station informs about the energy service outages like time of outage, locations, expected recovery time etc. The MNO device has information on a state of its power backup i.e. UPS backup duration at different base station locations, base station identifier (ID) that are enduring DSO's power outage and are depending on the UPS backup, base stations that provide communications services to DSOs substations for smart energy services implementation etc.

Another object of the embodiments herein is to provide that MNOs Rapid Intervention (MRI) is an approach by which the DSO station seeks dedicated communication service support from the MNO device using the UPS backup for network operations. The DSO station uses automated smart energy services like SCADA for rapid recovery of the energy distribution services.

Accordingly, embodiments herein disclose a mobile network operation (MNO) entity for coordinated service recovery in a wireless communication system, the MNO entity comprising: a transceiver; and at least one processor coupled to the transceiver and configured to: receive, from a distribution system operator (DSO) entity, a first create managed object instance (MOI) request for creating an information object class (IOC), wherein the create MOI request comprises a plurality of information attributes for outage and rapid recovery, create the IOC for the outage and rapid recovery of the DSO entity based on the plurality of information attributes received from the DSO entity, and transmit, to the DSO entity, a first create MOI response after creation of the IOC.

Accordingly, embodiments herein disclose a distribution system operator (DSO) entity for coordinated service recovery in a wireless communication system, the DSO entity comprising: a transceiver; and at least one processor coupled to the transceiver and configured to: create a first create managed object instance (MOI) request comprising a plurality of information attributes for outage and rapid recovery, transmit, to a mobile network operation (MNO) entity, the first create MOI request for creating an information object class (IOC) based on the plurality of information attributes for outage and rapid recovery, and receive, from the MNO entity, a first create MOI response after creation of the IOC by the MNO entity.

Accordingly, embodiments herein disclose a method performed by a mobile network operation (MNO) entity for coordinated service recovery in a wireless communication system, the method comprising: receiving, from a distribution system operator (DSO) entity, a first create managed object instance (MOI) request for creating an information object class (IOC), wherein the create MOI request comprises a plurality of information attributes for outage and rapid recovery; creating the IOC for the outage and rapid recovery of the DSO entity based on the plurality of information attributes received from the DSO entity; and transmitting, to the DSO entity, a first create MOI response after creation of the IOC.

Accordingly, embodiments herein disclose a method of a distribution system operator (DSO) entity for coordinated service recovery in a wireless communication system, the method comprising: creating a first create managed object instance (MOI) request comprising a plurality of information attributes for outage and rapid recovery; transmitting, to a mobile network operation (MNO) entity, the first create MOI request for creating an information object class (IOC) based on the plurality of information attributes for outage and rapid recovery; and receiving, from the MNO entity, a first create MOI response after creation of the IOC by the MNO entity.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DESCRIPTION OF DRAWINGS

The method and the wireless network are illustrated in the accompanying drawings, throughout which like reference letters indicate corresponding parts in the various figures. The embodiments herein will be better understood from the following description with reference to the drawings, in which:

FIG. 1 illustrates a wireless network for coordinated service recovery, according to the embodiments as disclosed herein;

FIG. 2 shows various hardware components of a MNO device, according to the embodiments as disclosed herein;

FIG. 3 shows various hardware components of a DSO station, according to the embodiments as disclosed herein;

FIG. 4 is a flow chart illustrating a method, implemented by the MNO device, for the coordinated service recovery in the wireless network, according to the embodiments as disclosed herein;

FIG. 5 is a flow chart illustrating a method, implemented by the DSO station, for the coordinated service recovery in the wireless network, according to the embodiments as disclosed herein; and

FIG. 6 illustrates a sequence diagram illustrating a method for performing the coordinated service recovery in network performance management in the wireless network, according to an embodiment as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein disclose a method for coordinated service recovery in a wireless network. The method includes receiving, by a MNO device, a create MOI request from a DSO station for creating an IOC. The create MOI request includes a plurality of information attributes for outage and rapid recovery. Further, the method includes creating, by the MNO device, the IOC for the outage and rapid recovery of the DSO station based on the plurality of information attributes received from the DSO station. Further, the method includes sending, by the MNO device, a create MOI response to the DSO station after creation of the IOC by the MNO device.

The proposed method can be used to ensure the coordinated service recovery in network performance management by performing mutual exchange of information between the DSO station and the MNO device using standardized interfaces exposed by a 3GPP network management system for rapid recovery of utility's energy service outage and subsequent fallback by the MNO device from its UPS to utility's energy supply for MNO communications service/network operations.

The proposed method utilizes a Natural Resource Management (NRM) based approach. That is, a provisioning Management Service (MnS) and related NRM fragments are used with the IOC and configurations defined as part of the proposed method. The DSO station uses DsoRapidRecovery IOC to configure the recovery related information like energy service outage, expected coordination from the MNO device, feasible coordination by the MNO device. Some of the attributes are also provided/updated by the MNO device such as for example but not limited to mnoInterventionTime, mnoInterventionDuration, mnoInterventionLocation. The DSO station uses the NtfSubscriptionControl to subscribe for notifyMOIAttributeValueChanges notifications in order to get notified about the information which MNO configures.

Further, the DSO station informs about the energy service outages like time of outage, locations, expected recovery time etc. The MNO device has information on the state of its power backup i.e. UPS backup duration at different base station locations, base station IDs that are enduring DSO's power outage and are depending on the UPS backup, base stations that provide communications services to DSOs substations for smart energy services implementation etc.

The MRI is the approach by which the DSO station seeks dedicated communication service support from the MNO device using the UPS backup for network operations. The DSO station uses automated smart energy services like SCADA for rapid recovery of energy distribution services.

The MNO device (100) can understand requirement of Rapid Intervention for DSO's rapid recovery of distribution services. The DSO station (200) is able to identify when they can perform remote restoration procedures given MNO device (100) can arrange to provide communication services at that time. The MNO device (100) can plan and prepare well its UPS power supply backup on its sites for communication services. The MNO device (100) protects the MNO sites from complete breakdown in case of UPS running out of its capacity due to prolonged DSO energy service outage. The MNO device (100) can know which MNO sites are affected, the estimate for how long, and when the energy outage ends for the sites. The MNO device (100) can clearly know at once when and at which sites it can fallback from UPS power backup to DSO's energy supply for its network operations.

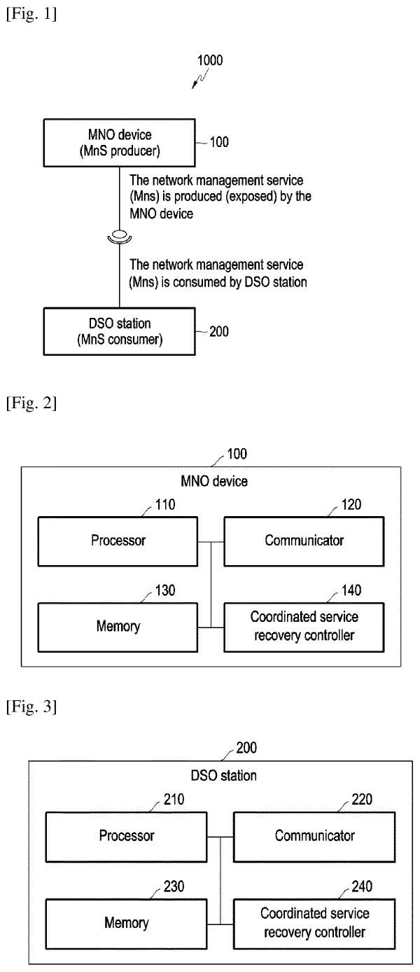

FIG. 1 illustrates a wireless network (1000) for coordinated service recovery, according to the embodiments as disclosed herein. In an embodiment, the wireless network (1000) includes a MNO device (100) and a DOS station (200). The wireless network (1000) can be, for example, but not limited to a fourth generation (4G) network, a fifth generation (5G) network, an Open Radio Access Network (ORAN) or the like. The DOS station (200) can be a management service (MnS) consumer and the MNO device (100) can be a management service (MnS) producer.

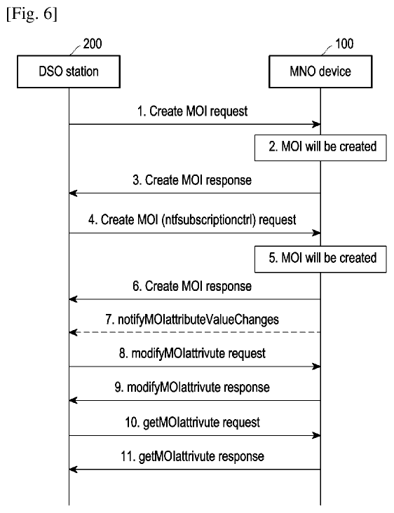

In an embodiment, the DOS station (200) creates a create MOI request including a plurality of information attributes for outage and rapid recovery by the DSO station (200). Further, the DOS station (200) sends the create MOI request to the MNO device (100) for creating an IOC. The details of the plurality of information attributes for the outage and rapid recovery are explained in the FIG. 6.

The MNO device (100) receives the create MOI request from the DSO station (200) for creating the IOC. Based on the plurality of information attributes received from the DSO station (200), the MNO device (100) creates the IOC for the outage and rapid recovery of the DSO station (200). After creation of the IOC by the MNO device (100), the MNO device (100) sends a create MOI response to the DSO station (200).

Further, the DSO station (200) creates a create MOI request including a plurality of notification subscription parameters for the DSO station (200). The details of the plurality of notification subscription parameters is explained in the FIG. 6. Further, the DSO station (200) sends the create MOI request to the MNO device (100) for creating a notification subscription control IOC. The MNO device (100) receives a create MOI request from the DSO station (200) for creation of the notification subscription control IOC. The create MOI request includes the plurality of notification subscription parameters. Based on the plurality of notification subscription parameters, the MNO device (100) creates the notification subscription control IOC. After creation of the notification subscription control IOC by the MNO device (100), the MNO device (100) sends a create MOI response to the DSO station (200).

Further, the MNO device (100) detects changes to the plurality of information attributes for the outage and rapid recovery IOC. Based on the notification subscription control IOC, the MNO device (100) sends a notification to the DSO station (200) informing about the changes to the plurality of information attributes.

In an embodiment, the DSO station (200) modifies an attribute from the plurality of attributes and sends a modify MOI attribute request corresponding to the modified attribute to the MNO device (100). Further, the MNO device (100) receives a modify MOI attribute request from the DSO station (200). The modify MOI attribute request corresponds to the attribute from the plurality of attributes modified by the DSO station (200). Further, the MNO device (100) sends a modify MOI attribute response to the DSO station (200).

In an embodiment, the DSO station (200) sends a get MOI attribute request to the MNO device (100) to retrieve the attribute of the plurality of attributes from the MNO device (100). Further, the MNO device (100) receives a get MOI attribute request from the DSO station (200) to retrieve the attribute from the plurality of attributes. Further, the MNO device (100) sends a get MOI attribute response including the attribute to the DSO station.

FIG. 2 shows various hardware components of the MNO device (100), according to the embodiments as disclosed herein. In an embodiment, the MNO device (100) includes a processor (110), a communicator (120), a memory (130) and a coordinated service recovery controller (140). The processor (110) is coupled with the communicator (120), the memory (130) and the coordinated service recovery controller (140), and controls the overall operation of the network entity in the method as described above. The present invention is not limited to the above example, and the MNO device (100) may include more or fewer configurations than the configuration shown in FIG. 2.

The communicator (120) is referred to a transceiver. The transceiver may transmit and receive signals to and from network entities. In addition, the transceiver can receive a signal through a wireless channel and output it to the processor, and transmit the signal output from the processor through a wireless channel.

The coordinated service recovery controller (140) receives the create MOI request from the DSO station (200) for creating the IOC. The create MOI request includes the plurality of information attributes for outage and rapid recovery. Based on the plurality of information attributes received from the DSO station (200), the coordinated service recovery controller (140) creates the IOC for the outage and rapid recovery of the DSO station. After creation of the IOC by the MNO device (100), the coordinated service recovery controller (140) sends the create MOI response to the DSO station (200).

Further, the coordinated service recovery controller (140) receives the create MOI request from the DSO station for creation of the notification subscription control IOC to the MNO device (100). The create MOI request includes the plurality of notification subscription parameters. Based on the plurality of notification subscription parameters, the coordinated service recovery controller (140) creates the notification subscription control IOC. After creation of the notification subscription control IOC by the MNO device (100), the coordinated service recovery controller (140) sends the create MOI response to the DSO station (200).

Further, the coordinated service recovery controller (140) detects changes to the plurality of information attributes for the outage and rapid recovery IOC. Based on the notification subscription control IOC, the coordinated service recovery controller (140) sends the notification to the DSO station (200) informing about the changes to the plurality of information attributes.

Further, the coordinated service recovery controller (140) receives the modify MOI attribute request from the DSO station (200). The modify MOI attribute request corresponds to the attribute from the plurality of attributes modified by the DSO station (200). Further, the coordinated service recovery controller (140) sends the modify MOI attribute response to the DSO station (200).

Further, the coordinated service recovery controller (140) receives the get MOI attribute request from the DSO station (200) to retrieve the attribute from the plurality of attributes. Further, the coordinated service recovery controller (140) sends the get MOI attribute response including the attribute to the DSO station (200).

The coordinated service recovery controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the MNO device (100) but it is to be understood that other embodiments are not limited thereon. In other embodiments, the MNO device (100) may include less or more number of components. Further, the labels or names of the components are used only for illustrative purpose and does not limit the scope of the invention. One or more components can be combined together to perform same or substantially similar function in the MNO device (100).

FIG. 3 shows various hardware components of the DSO station (200), according to the embodiments as disclosed herein. In an embodiment, the DSO station (200) includes a processor (210), a communicator (220), a memory (230) and a coordinated service recovery controller (240). The processor (210) is coupled with the communicator (220), the memory (230) and the coordinated service recovery controller (240), and controls the overall operation of the network entity in the method as described above. The present invention is not limited to the above example, and the DSO station (200) may include more or fewer configurations than the configuration shown in FIG. 3.

The communicator (220) is referred to a transceiver. The transceiver may transmit and receive signals to and from network entities. In addition, the transceiver can receive a signal through a wireless channel and output it to the processor, and transmit the signal output from the processor through a wireless channel.

The coordinated service recovery controller (240) creates the create MOI request including the plurality of information attributes for outage and rapid recovery. Further, the coordinated service recovery controller (240) sends the create MOI request to the MNO device (100) for creating the IOC based on the plurality of information attributes for outage and rapid recovery. After creation of the IOC by the MNO device (100), the coordinated service recovery controller (240) receives the create MOI response from the MNO device (100).

Further, the coordinated service recovery controller (240) creates the create MOI request including the plurality of notification subscription parameters for the DSO station (200). Further, the coordinated service recovery controller (240) sends the create MOI request to the MNO device (100) for creating the notification subscription control IOC as per the plurality of notification subscription parameters. After creation of the notification subscription control IOC by the MNO device (100), the coordinated service recovery controller (240) receives the create MOI response from the MNO device (100).

Further, the coordinated service recovery controller (240) receives the notification based on the notification subscription control IOC informing about the changes to the plurality of information attributes in the outage and rapid recovery IOC.

In an embodiment, the coordinated service recovery controller (240) modify the attribute from the plurality of attributes and sends the modify MOI attribute request corresponding to the modified attribute to the MNO device (100). Further, the coordinated service recovery controller (240) receives the modify MOI attribute response from the MNO device (100).

In an embodiment, the coordinated service recovery controller (240) sends the get MOI attribute request to the MNO device (100) to retrieve the attribute of the plurality of attributes from the MNO device (100). Further, the coordinated service recovery controller (240) receives the modify MOI attribute response including the attribute from the MNO device (100).

The coordinated service recovery controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the DSO station (200) but it is to be understood that other embodiments are not limited thereon. In other embodiments, the DSO station (200) may include less or more number of components. Further, the labels or names of the components are used only for illustrative purpose and does not limit the scope of the invention. One or more components can be combined together to perform same or substantially similar function in the DSO station (200).

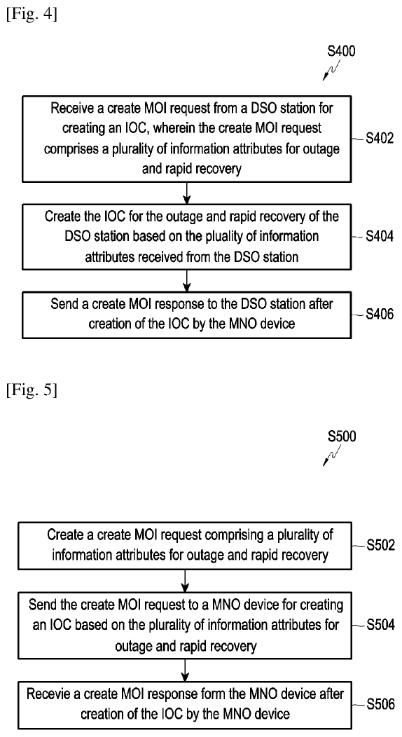

FIG. 4 is a flow chart (400) illustrating a method, implemented by the MNO device (100), for the coordinated service recovery in the wireless network (1000), according to the embodiments as disclosed herein. The operations (S402-S406) are handled by the coordinated service recovery controller (140).

At step S402, the method includes receiving the create MOI request from the DSO station (200) for creating the IOC. The create MOI request includes the plurality of information attributes for outage and rapid recovery. At step S404, the method includes creating the IOC for the outage and rapid recovery of the DSO station (200) based on the plurality of information attributes received from the DSO station (200). At step S406, the method includes sending the create MOI response to the DSO station (200) after creation of the IOC by the MNO device (100).

FIG. 5 is a flow chart (S500) illustrating a method, implemented by the DSO station (200), for the coordinated service recovery in the wireless network (1000), according to the embodiments as disclosed herein. The operations (S502-S506) are handled by the coordinated service recovery controller (240). At step S502, the method includes creating the create MOI request including the plurality of information attributes for outage and rapid recovery. At step S504, the method includes sending the create MOI request to the MNO device (100) for creating the IOC based on the plurality of information attributes for outage and rapid recovery. At step S506, the method includes receiving the create MOI response from the MNO device (100) after creation of the IOC by the MNO device (100).

The proposed method enables efficient usage of smart energy services for DSO's service recovery and actually provides multiple business values for the DSO station (200) and the MNO device (100) with less time.

FIG. 6 illustrates a sequence diagram illustrating a method for performing the coordinated service recovery in the network performance management in the wireless network (1000), according to an embodiment as disclosed herein.

At step 1, the DSO station (200) sends the createMOI for a DsoRapidRecovery IOC to the MNO device (100). The createMOI includes following attributes:
1. The attribute dsoServiceOutageInfo contains following sub-attributes:
a) dsoOutStartTime gives a time stamp of DSO's energy distribution service outage.
b) dsoOutRegion gives an information of regions where DSO's energy service outage occurs e.g. DSO's substations having outage are situated in a specified region.
c) dsoRestoreTimeExpected gives the time by when the DSO station (200) expects restoration of its distribution services for the MNO device (100).
2. The attributedsoRapidInterventionInfo contains following sub-attributes:
a) dsoTransmissionRestoreTime gives the time when the DSO station (200) has restored its energy transmission service and starts expecting MRI by the MNO device (100).
b) dsoRequiredInterventionDuration gives the time duration for which the DSO station (200) expects to require MNO's rapid intervention service for being able to use smart energy services to restore its energy distribution services.
c) dsoPriorityRecoveryLocation gives the information of regions where for example DSO substations need to restore distribution services on priority.
3. The attribute mnoRapidInterventionInfo contains following sub-attributes:
a) mnoInterventionTime gives the time at which the MNO device (100) is actually able to provide rapid intervention service to the DSO station (200).
b) mnoInterventionDuration gives the time duration for which the MNO device (100) is actually able to provide rapid intervention service to the DSO station (200).
c) mnoInterventionLocation gives the information of regions where the MNO device (100) is actually able to provide rapid intervention service to the DSO station (200).
4. The attribute dsoServiceRestoreInfo contains following sub-attributes:
a) dsoRestoreTimeActual gives the time stamp at which DSO's energy distribution services has been finally restored.
b) dsoRestoreLocationActual gives the information of regions where (e.g. DSO substations) distribution energy service has been finally restored.

At step 2, the MNO device (100) creates the MOI. At step 3, the MNO device (100) sends the createMOI response to the DSO station (200). At step 4, the DSO station (200) sends the createMOI for NtfSubscriptionControl IOC to the MNO device (100). The createMOI for NtfSubscriptionControl IOC includes following attributes:
a) The attribute notificationRecipientAddress contains the address of the notification recipient i.e. DSO station (200).
b) The attribute notificationTypes contains the notification notifyMOIAttributeValueChanges. The notification notifyMOIAttributeValueChanges is forwarded to the DSO station (200).
c) The attribute notificationFilter indicates a filter to be applied to candidate notifications identified by the notificationTypes attribute. Only notifications that pass the filter criteria are forwarded to the notification recipient.

At step 5, the MNO device (100) creates the MOI. At step 6, the MNO device (100) sends the createMOI response to the DSO station (200). At step 7, the MNO device (100) sends the notifyMOIattributeValueChanges to the DSO station (200).

At step 8, the DSO station (200) sends the modifyMOIattribute request to the MNO device (100). The modifyMOIattribute request corresponds to the attribute from the plurality of attributes modified by the DSO station (200). At step 9, the MNO device (100) sends the modify MOI attribute response to the DSO station (200).

At step 10, the DSO station (200) sends the getMOIattribute request to the MNO device (100). At step 11, the MNO device (100) sends the getMOIattribute response to the DSO station (200).

Note that from this point onwards, the DSO station (200) can use provisioning MnS (defined in 3GPP TS 28.532) to perform Create Read Update Delete (CRUD) operation on the MOI created.

The details of the plurality of information attributes for the outage and rapid recovery and the details of the plurality of notification subscription parameters are explained below.

### IOC Definition:

DsoRapidRecovery: The IOC represents the mutual information exchange between the DSO station (200) and the MNO device (100) to achieve rapid recovery of DSO's energy service outage for all DSO sites which require service restoration.

### Attributes

TABLE 1

| | Support | | | | |
|---|---|---|---|---|---|
| Attribute name | Qualifier | isReadable | isWritable | isInvariant | isNotifyable |
| administrativeState | Mandatory | True | T | False | T |
| | (M) | (T) | | (F) | |
| operationalState | M | T | F | F | T |
| dSORapidRecoveryInfo | M | T | F | F | T |

DSORapidRecovery Info «dataType»

Definition: The «dataType» defines the DSO recovery related information for the particular location/region.

### Attributes

TABLE 2

| | | isRead- | isWrit- | isInvari- | isNotify- |
|---|---|---|---|---|---|
| Attribute name | S | able | able | ant | able |
| dsoServiceOutageInfo | M | T | T | F | T |
| dsoRapidInterventionInfo | M | T | T | F | T |
| mnoRapidInterventionInfo | M | T | T | F | T |
| dsoServiceRestoreInfo | M | T | T | F | T |

ServiceOutageInfo «dataType» Definition

The «dataType» defines several information shared by the DSO station (200) to the MNO device (100) related to its energy service outage like starting time of DSO energy service outage, outage substation locations etc.

The attribute dsoOutStartTime defines the time stamp at which the DSO energy service outage occurs. Along with outage locations and expected recovery time this could be beneficial for the MNO device (100) to plan and prepare (e.g., when and where to activate and de-activate) its UPS power backup at different site locations for its crucial communication services and also for assisting the DSO station (200) for the MRI (MNO Rapid Intervention). In case of the MRI assistance, the MNO device (100) may reserve its UPS resources to be used when required.

The attribute dsoOutRegion defines the regions where the DSO energy service outage occurs. These are usually the locations where DSO subsystems are situated. The attribute dsoOutRegion is usually defined as latitude-longitude pair and meterId. The point defined by the Latitude-Longitude pair serves as one point of an area polygon defining the region. The meterId identifies the MNO device (100) using DSO energy services. The meterId is communicated between both the parties using out-of-band mechanism hence not subject to standardization.

The attribute dsoRestoreTimeExpected defines the time by which the DSO station (200) expects its energy distribution service to be restored through its manual dispatch and processes. The attribute dsoRestoreTimeExpected is usually a much longer time duration that may not be acceptable for some crucial public services like hospitals.

### Attributes

TABLE 3

| | | isRead- | isWrit- | | isNotify- |
|---|---|---|---|---|---|
| Attribute name | S | able | able | isInvariant | able |
| dsoOutStartTime | M | T | T | F | T |
| dsoOutRegion | M | T | T | F | T |
| dsoRestoreTimeExpected | M | T | T | F | T |

DsoInterventionInfo «dataType»

### DEFINITION

The «dataType» defines several information shared by the DSO station (200) to the MNO device (100) related to its requirement for the MRI.

The attribute dsoTransmissionRestoreTime defines the time at which the DSO station (200) restores its Energy “transmission” service. For DSO's distribution service to restore first its transmission line/service needs to be restored. From this time, the DSO station (200) can use its automated smart energy services e.g. SCADA to recover its distribution services much quicker in substations instead of manual processes but for the MNO's communication services via the MRI is required to the DSO station (200). Hence this is also the time from when the DSO station (200) expects the MRI to start. The attribute dsoRequiredInterventionDuration defines time “duration” for which the DSO station (200) requires the MRI in order to restore its energy distribution services rapidly. The time duration is usually defined in minutes.

The attribute dsoPriorityRecoveryLocation defines the locations of the DSO substations that need recovery on priority by using smart energy services because some of the substations locations might be providing electrical energy for crucial services like hospitals, mission critical service avenues, government offices etc. The attribute dsoPriorityRecoveryLocation is used by the MNO device (100) to ascertain gNBs at which the UPS power needs to be reserved as part of MRI because the gNBs are servicing these substations. The attribute dsoPriorityRecoveryLocation is usually defined as latitude-longitude pair. The point defined by the Latitude-Longitude pair serves as one point of an area polygon defining the region containing substation.meterId identifies the MNO device (100) using DSO energy services. The meterId is communicated between both the parties using out-of-band mechanism hence not subject to standardisation.

### Attributes

TABLE 4

| Attribute name | S | isReadable | isWritable | isInvariant | isNotifyable |
|---|---|---|---|---|---|
| dsoTransmissionRestoreTime | M | T | T | F | T |
| dsoRequiredInterventionDuration | M | T | T | F | T |
| dsoPriorityRecoveryLocation | M | T | T | F | T |

MnoInterventionInfo «dataType»

### DEFINITION

The «dataType» defines several information shared by the MNO device (100) to the DSO station (200) for feasible fulfillment of DSO's rapid recovery requirements by the MNO device (100). The MnoInterventionInfo may be possible that instead of full, some part of requested MRI requirements MNO is actually able to cater in terms of intervention start time, location etc.

The attribute mnoInterventionTime defines the time at which the MNO device (100) will actually be able to provide dedicated communications services to the DSO station (200) (as MRI) depending on its site's UPS backup status, engagement in other critical service avenues etc. The DSO station (200) needs attribute mnoInterventionTime to use its smart energy services like SCADA for recovering its energy distribution services.

The attribute mnoInterventionDuration defines the time duration for which the MNO device (100) will actually be able to provide dedicated communications services to the DSO station (200) (as MRI) depending on its UPS backup status, engagement in other critical service avenues etc. The time duration is usually defined in minutes.

The attribute mnoInterventionLocation defines the locations having DSO's substations where its actually feasible for the MNO device (100) to provide its dedicated communications services (as MRI) for DSO's smart energy services usage. The criteria for location feasibility may depend on MNO's UPS backup status per site, or other prior crucial service commitments in other locations like hospital, government offices etc. The attribute mnoInterventionLocation is usually defined as latitude-longitude pair and meterId. The point defined by the Latitude-Longitude pair serves as one point of an area polygon defining the region containing substation.meterId identifies the MNO facility using DSO energy services. meterId is communicated between both the parties using out-of-band mechanism hence not subject to standardization.

### Attributes

TABLE 5

| | | isRead- | isWrit- | | isNotify- |
|---|---|---|---|---|---|
| Attribute name | S | able | able | isInvariant | able |
| mnoInterventionTime | M | T | T | F | T |
| mnoInterventionDuration | M | T | T | F | T |
| mnoInterventionLocation | M | T | T | F | T |

ServiceRestoreInfo «dataType»

### DEFINITION

The «dataType» defines information shared by the DSO station (200) to the MNO device (100) regarding actual final restoration of DSO's distribution services. From the MNO device (100) gets to know at what time it can stop its MRI services for the DSO station (200) and at which locations. The MNO device (100) also gets to know when and where gNB sites (for example) does not need the UPS backup anymore for its communication services/operations. The DSO station (200) will update the information once the service has been restored.

The attribute dsoRestoreTimeActual defines the time at which the DSO station (200) finally restores its energy distribution services rapidly by using MRI. The time of the dsoRestoreTimeActual is much smaller than dsoRestoreTimeExpected.

The attribute dsoRestoreLocationActual defines the Ssbstation locations where the DSO station (200) is able to finally restore its energy distribution services. These may be same or fewer than dsoPriorityRecoveryLocation or mnoInterventionLocation. The dsoRestoreLocationActual is usually defined as latitude-longitude pair and meterId. The point defined by the Latitude-Longitude pair serves as one point of an area polygon defining the region.meterId identifies the MNO facility using DSO energy services. meterId is communicated between both the parties using out-of-band mechanism hence not subject to standardization.

### Attributes

TABLE 6

| | | isRead- | isWrit- | isInvari- | isNotify- |
|---|---|---|---|---|---|
| Attribute name | S | able | able | ant | able |
| dsoRestoreTimeActual | M | T | T | F | T |
| dsoRestoreLocationActual | M | T | T | F | T |

ServiceLocationIdentifier «datatype»

### DEFINITION

The «datatype» defines information shared by the DSO station (200) to the MNO device (100) regarding location of the DSO distribution facility in terms of latitude, longitude and meterId. The point defined by the Latitude-Longitude pair serves as one point of an area polygon defining the region.meterId identifies the MNO facility using the DSO energy services. The meterId is communicated between both the parties using out-of-band mechanism hence not subject to standardization.

TABLE 7

| Attribute name | S | isReadable | isWritable | isInvariant | isNotifyable |
|---|---|---|---|---|---|
| latitude | M | T | T | F | T |
| longitude | M | T | T | F | T |
| meterId | O | T | T | F | T |

### Attribute Definition

The following table defines the properties of attributes specified in the present disclosure.

TABLE 8

| Attribute Name | Documentation and Allowed Values | Properties |
|---|---|---|
| dSORapidRecoveryInfo | The dSORapidRecoveryInfo defines | type: DSORapidRecoveryInfo |
| | the DSO and MNO coordinated | multiplicity:1.* |
| | recovery related information for a | isOrdered: N/A |
| | particular location/region. | isUnique: Yes |
| | | defaultValue: None |
| | | isNullable: False |
| dsoServiceOutageInfo | Contains list of attributes that define | type: ServiceOutageInfo |
| | several information shared by DSO to | multiplicity: 1 |
| | MNO related to its energy service | isOrdered: N/A |
| | outage like starting time of DSO | isUnique: N/A |
| | energy service outage, outage | defaultValue: None |
| | locations, expected restore time of | isNullable: False |
| | outage. | |
| dsoRapidInterventionInfo | Contains list of attributes that define | type: DsoInterventionInfo |
| | several information shared by DSO to | multiplicity: 1 |
| | MNO related to its requirement for | isOrdered: N/A |
| | MNO's Rapid Intervention (MRI) like | isUnique: N/A |
| | expected time to start MRI, expected | defaultValue: None |
| | duration of MRI, expected locations | isNullable: False |
| | that require MRI on priority. | |
| mnoRapidInterventionInfo | Contains list of attributes that define | type: MnoInterventionInfo |
| | several information shared by MNO to | multiplicity: 1 |
| | DSO for feasible fulfillment of DSO's | isOrdered: N/A |
| | rapid recovery requirements by MNO. | isUnique: N/A |
| | It may be possible that instead of full, | defaultValue: None |
| | some part of requested MRI | isNullable: False |
| | requirements MNO is actually able to | |
| | cater in terms of intervention start time, | |
| | location, intervention duration. | |
| dsoServiceRestoreInfo | Contains list of attributes that define | type: ServiceRestoreInfo |
| | information shared by DSO to MNO | multiplicity: 1 |
| | regarding actual final restoration of | isOrdered: N/A |
| | DSO's distribution services. From the | *168isUnique: N/A |
| | information, MNO gets to know at | defaultValue: None |
| | what time it can stop its MRI services | isNullable: False |
| | for DSO and at which locations. MNO | |
| | also gets to know when and where | |
| | (gNB sites) it does not need UPS | |
| | backup anymore for its communication | |
| | services/operations. | |
| dsoOutStartTime | Time stamp at which the DSO energy | type: DateTime |
| | service outage occurs. | multiplicity: 1 |
| | | isOrdered: N/A |
| | | isUnique: N/A |
| | | defaultValue: None |
| | | isNullable: False |
| dsoOutRegion | Regions where DSO energy service | Type: |
| | outage occurs. These are the locations | ServiceLocationIdentifier |
| | where DSO subsystems are | multiplicity: 1 |
| | situated. The dsoOutRegion is defined | isOrdered: N/A |
| | as latitude -longitude pair and meterId. | isUnique: N/A |
| | The point defined by the Latitude- | defaultValue: None |
| | Longitude pair serves as one point of | isNullable: False |
| | an area polygon defining the | |
| | region.meterId identifies the MNO | |
| | facility using DSO energy services. | |
| | meterId is communicated between both | |
| | the parties using out-of-band | |
| | mechanism hence not subject to | |
| | standardisation. | |
| dsoRestoreTimeExpected | Time by which DSO expects its energy | type: DateTime |
| | distribution service to get restored | multiplicity: 1 |
| | through its manual dispatch and | isOrdered: N/A |
| | processes. The | isUnique: N/A |
| | dsoRestoreTimeExpected is usually a | defaultValue: None |
| | longer time period that may not be | isNullable: False |
| | acceptable for some crucial public | |
| | services like hospitals. | |
| dsoTransmissionRestoreTime | Time at which DSO restores its Energy | type: DateTime |
| | “Transmission” service. The | multiplicity: 1 |
| | dsoTransmissionRestoreTime is the | isOrdered: N/A |
| | time from when the DSO expectMRI to | isUnique: N/A |
| | start. | defaultValue: None |
| | | isNullable: False |
| dsoRequiredInterventionDuration | Time duration for which the DSO | Type: Integer |
| | requires MRIin order to restore its | multiplicity: 1 |
| | energy distribution services rapidly. | isOrdered: N/A |
| | The time duration is defined in | isUnique: N/A |
| | minutes. | defaultValue: None |
| | allowedValues: Integer with a | isNullable: False |
| | minimum value of 1 | |
| dsoPriorityRecoveryLocation | Locations of DSO substations that need | Type:ServiceLocationIdentifier |
| | recovery on priority by using smart | multiplicity: 1 |
| | energy services. The | isOrdered: N/A |
| | dsoPriority Recovery Location is | isUnique: N/A |
| | defined as latitude-longitude pair and | defaultValue: None |
| | meterId. | isNullable: False |
| | The dsoPriorityRecoveryLocation can | |
| | be used by MNO to ascertain the | |
| | gNBsat which the UPS power needs to | |
| | be reserved as part of MRI. The point | |
| | defined by the Latitude-Longitude pair | |
| | serves as one point of an area polygon | |
| | defining the region.meterId identifies | |
| | the MNO facility using DSO energy | |
| | services. meterId is communicated | |
| | between both the parties using out-of- | |
| | band mechanism hence not subject to | |
| | standardisation. | |
| mnoInterventionTime | Time at which a MNO will actually be | type: DateTime |
| | able to provide dedicated | multiplicity: 1 |
| | communications services to DSO (as | isOrdered: N/A |
| | MRI) depending on its UPS backup | isUnique: N/A |
| | status, other critical service avenues | defaultValue: None |
| | etc. DSO needs to use its smart energy | isNullable: False |
| | services like SCADA for recovering its | |
| | energy distribution services. | |
| mnoInterventionDuration | Time duration for which a MNO will | Type: Integer |
| | actually be able to provide dedicated | multiplicity: 1 |
| | communications services to DSO (as | isOrdered: N/A |
| | MRI) depending on its UPS backup | isUnique: N/A |
| | status, other critical service avenues | defaultValue: None |
| | etc. | isNullable: False |
| | The time duration is defined in | |
| | minutes. | |
| | allowedValues: Integer with a | |
| | minimum value of 1 | |
| mnoInterventionLocation | Locations having DSO's substations | Type: |
| | where its actually feasible for MNO to | ServiceLocationIdentifier |
| | provide its dedicated communications | multiplicity: 1 |
| | services (as MRI) for DSO's smart | isOrdered: N/A |
| | energy services usage. The criteria for | isUnique: N/A |
| | location feasibility may depend on | defaultValue: None |
| | MNO's UPS backup status per site, or | isNullable: False |
| | other prior crucial service | |
| | commitments in other locations like | |
| | hospital, government offices etc.The | |
| | mnoInterventionLocation is defined as | |
| | latitude-longitude pair and meterId. | |
| | The point defined by the Latitude- | |
| | Longitude pair serves as one point of | |
| | an area polygon defining the | |
| | region.meterId identifies the MNO | |
| | facility using DSO energy services. | |
| | meterId is communicated between both | |
| | the parties using out-of-band | |
| | mechanism hence not subject to | |
| | standardisation. | |
| dsoRestoreTimeActual | Time at which DSO finally restores its | type: DateTime |
| | energy distribution services rapidly by | multiplicity: 1 |
| | using MRI. The time is much smaller | isOrdered: N/A |
| | than dsoRestore TimeExpected | isUnique: N/A |
| | | defaultValue: None |
| | | isNullable: False |
| dsoRestoreLocationActual | Substation locations where DSO is able | Type: |
| | to finally restore its energy distribution | ServiceLocationIdentifier |
| | services. These may be same or fewer | multiplicity: 1 |
| | than dsoPriorityRecoveryLocation or | isOrdered: N/A |
| | mnoInterventionLocation. | isUnique: N/A |
| | The dsoRestoreLocationActual is | defaultValue: None |
| | defined as latitude-longitude pair and | isNullable: False |
| | meterId. | |
| | The point defined by the Lat/Log pair | |
| | serves as one point of an area polygon | |
| | defining the region.meterId identifies | |
| | the MNO facility using DSO energy | |
| | services. meterId is communicated | |
| | between both the parties using out-of- | |
| | band mechanism hence not subject to | |
| | standardisation. | |
| latitude | Defines the latitude | type: integer |
| | | multiplicity: 1 |
| | | isOrdered: N/A |
| | | isUnique: N/A |
| | | defaultValue: None |
| | | isNullable: False |
| longitude | Defines the longitude | type: integer |
| | | multiplicity: 1 |
| | | isOrdered: N/A |
| | | isUnique: N/A |
| | | defaultValue: None |
| | | isNullable: False |
| meterId | meterId identifies the MNO facility | type: String |
| | using DSO energy services. meterId is | multiplicity: 1.* |
| | communicated between both the | isOrdered: N/A |
| | parties using out-of-band mechanism | isUnique: True |
| | hence not subject to standardisation. | defaultValue: None |
| | | isNullable: False |

The proposed method provides standardized mechanism for the DSO station (200) to share and receive its outage and recovery related information with the MNO device (100) for rapid recovery of its distribution services. The sharing of DSO's energy service outage and recovery information to the MNO device (100) has mutual benefits. The MNO device (100) can plan and prepare well its UPS power supply backup on its sites for communication services.

The MNO device (100) can know which MNO sites are affected, the estimate for how long, and when the energy outage ends for the sites. The DSO station (200) identifies when they can perform remote restoration procedures given communication and the MNO device (100) can arrange to provide communication services at that time. The MNO device (100) can understand DSO's requirement of MNO's Rapid Intervention and can support the DSO station (200) for its rapid recovery of distribution services. The MNO device (100) can clearly know at once when and at which sites it can fallback from UPS power backup to DSO's energy supply for its network operations.

Accordingly, embodiments herein disclose a method for coordinated service recovery in a wireless network. The method includes receiving, by a MNO device, a create MOI request from a DSO station for creating an IOC. The create MOI request includes a plurality of information attributes for outage and rapid recovery. Further, the method includes creating, by the MNO device, the IOC for the outage and rapid recovery of the DSO station based on the plurality of information attributes received from the DSO station. Further, the method includes sending, by the MNO device, a create MOI response to the DSO station after creation of the IOC by the MNO device.

In an embodiment, the plurality of information attributes includes at least one of a time stamp of an outage of energy distribution service of the DSO station, location where energy service outage of the DSO station occurs, an energy supply identifier, a time by when the DSO station expects restoration of distribution services for the MNO device, a time when the DSO station restored energy transmission service and starts expecting rapid intervention by the MNO device, a time duration for which the DSO station expects to require the rapid intervention by the MNO device for being able to use smart energy services to restore the energy distribution services, information of locations where DSO substations need to restore distribution services on priority, a time at which the MNO device provide the rapid intervention to the DSO station, a time duration for which the MNO device provide the rapid intervention to the DSO station, information of locations where the MNO device provides the rapid intervention to the DSO station, a time stamp at which the energy distribution services from the DSO station are restored, and information of locations where distribution energy service from the DSO substations restored.

In an embodiment, the method includes receiving, by the MNO device, a create MOI request from the DSO station for creation of a notification subscription control IOC to the MNO device. The create MOI request includes a plurality of notification subscription parameters. Furter, the method includes creating, by the MNO device, the notification subscription control IOC based on the plurality of notification subscription parameters. Furter, the method includes sending, by the MNO device, a create MOI response to the DSO station after creation of the notification subscription control IOC by the MNO device.

In an embodiment, the method includes detecting, by the MNO device, changes to the plurality of information attributes for outage and rapid recovery IOC. Furter, the method includes sending, by the MNO device, a notification to the DSO station informing about the changes to the plurality of information attributes based on the notification subscription control IOC.

In an embodiment, the plurality of notification subscription parameters includes at least one of a notification recipient address attribute having an address of the DSO station, a notification types attribute having a notify MOI attribute value changes, and an attribute notification filter indicating a filter to be applied to candidate notifications identified by the notification types attribute.

In an embodiment, the method includes receiving, by the MNO device, a modify MOI attribute request from the DSO station. The modify MOI attribute request corresponds to at least one attribute from the plurality of attributes modified by the DSO station. Furter, the method includes sending, by the MNO device, a modify MOI attribute response to the DSO station.

In an embodiment, the method includes receiving, by the MNO device, a get MOI attribute request from the DSO station to retrieve at least one attribute from the plurality of attributes. Furter, the method includes sending, by the MNO device, a get MOI attribute response comprising the at least one attribute to the DSO station.

Accordingly, embodiments herein disclose a method for coordinated service recovery in a wireless network. The method includes creating, by a DSO station, a create MOI request comprising a plurality of information attributes for outage and rapid recovery. Furter, the method includes sending, by a DSO station, the create MOI request to a MNO device for creating an IOC based on the plurality of information attributes for outage and rapid recovery. Furter, the method includes receiving, by the DSO station, a create MOI response from the MNO device after creation of the IOC by the MNO device.

In an embodiment, the method includes creating, by the DSO station, a create MOI request comprising a plurality of notification subscription parameters for the DSO station. Furter, the method includes sending, by the DSO station, the create MOI request to the MNO device for creating a notification subscription control IOC as per the plurality of notification subscription parameters. Furter, the method includes receiving, by the DSO station, a create MOI response from the MNO device after creation of the notification subscription control IOC by the MNO device.

In an embodiment, the method includes receiving, by the DSO station, a notification based on the notification subscription control IOC informing about the changes to the plurality of information attributes in the outage and rapid recovery IOC.

In an embodiment, the method includes modifying, by the DSO station, at least one attribute from the plurality of attributes. Furter, the method includes sending, by the DSO station, a modify MOI attribute request corresponding to the at least one modified attribute to the MNO device. Furter, the method includes receiving, by the DSO station, a modify MOI attribute response from the MNO device.

In an embodiment, the method includes sending, by the DSO station, a get MOI attribute request to the MNO device to retrieve at least one attribute of the plurality of attributes from the MNO device. Furter, the method includes receiving, by the DSO station, a modify MOI attribute response comprising the at least one attribute from the MNO device.

Accordingly, embodiments herein disclose a MNO device for coordinated service recovery in a wireless network. The MNO device includes a coordinated service recovery controller communicatively coupled to a memory and a processor. The coordinated service recovery controller is configured to receive a create MOI request from a DSO station for creating an IOC. The create MOI request includes a plurality of information attributes for outage and rapid recovery. Further, the coordinated service recovery controller is configured to create the IOC for the outage and rapid recovery of the DSO station based on the plurality of information attributes received from the DSO station. Further, the coordinated service recovery controller is configured to send a create MOI response to the DSO station after creation of the IOC by the MNO device.

Accordingly, embodiments herein disclose a DSO station for coordinated service recovery in a wireless network. The DSO station includes a coordinated service recovery controller communicatively coupled to a memory and a processor. The coordinated service recovery controller is configured to create a create MOI request comprising a plurality of information attributes for outage and rapid recovery. Further, the coordinated service recovery controller is configured to send the create MOI request to a MNO device for creating an IOC based on the plurality of information attributes for outage and rapid recovery. Further, the coordinated service recovery controller is configured to receive a create MOI response from the MNO device after creation of the IOC by the MNO device.

The various actions, acts, blocks, steps, or the like in the flow charts (S400 and S500) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A mobile network operation (MNO) entity for coordinated service recovery in a wireless communication system, the MNO entity comprising:
a transceiver; and
at least one processor coupled to the transceiver and configured to:
receive, from a distribution system operator (DSO) entity, a first create managed object instance (MOI) request for creating an information object class (IOC), wherein the create MOI request includes a plurality of information attributes for outage and rapid recovery,
create the IOC for the outage and rapid recovery of the DSO entity based on the plurality of information attributes received from the DSO entity, and
transmit, to the DSO entity, a first create MOI response after creation of the IOC.

2. The MNO entity of claim 1, wherein the plurality of information attributes includes at least one of:
a time stamp of an outage of energy distribution service of the DSO entity,
first information of regions where energy service outage of the DSO entity occurs,
a time by when the DSO entity expects restoration of distribution services for the MNO entity,
a time when the DSO entity restored energy transmission service and starts expecting rapid intervention by the MNO entity,
a time duration for which the DSO entity expects to require the rapid intervention by the MNO entity for being able to use smart energy services to restore the energy distribution services,
second information of locations where DSO substations need to restore distribution services on priority,
a time at which the MNO entity provide the rapid intervention to the DSO entity,
a time duration for which the MNO entity provide the rapid intervention to the DSO entity,
third information of regions where the MNO entity provides the rapid intervention to the DSO entity,
a time stamp at which the energy distribution services from the DSO entity are restored, and
fourth information of regions where distribution energy service from the DSO substations restored.

3. The MNO entity of claim 1, wherein the at least one processor is configured to:
receive, from the DSO entity, a second create MOI request for creation of a notification subscription control IOC to the MNO entity, wherein the second create MOI request includes a plurality of notification subscription parameters;
create the notification subscription control IOC based on the plurality of notification subscription parameters; and
transmit, to the DSO entity, a second create MOI response after creation of the notification subscription control IOC.

4. The MNO entity of claim 3, wherein the at least one processor is further configured to:
detect changes to the plurality of information attributes for outage and rapid recovery IOC; and
transmit, to the DSO entity, a notification informing about the changes to the plurality of information attributes based on the notification subscription control IOC.

5. A distribution system operator (DSO) entity for coordinated service recovery in a wireless communication system, the DSO entity comprising:
a transceiver; and
at least one processor coupled to the transceiver and configured to:
create a first create managed object instance (MOI) request including a plurality of information attributes for outage and rapid recovery,
transmit, to a mobile network operation (MNO) entity, the first create MOI request for creating an information object class (IOC) based on the plurality of information attributes for outage and rapid recovery, and
receive, from the MNO entity, a first create MOI response after creation of the IOC by the MNO entity.

6. The DSO entity of claim 5, wherein the plurality of information attributes includes at least one of:
a time stamp of an outage of energy distribution service of the DSO entity,
first information of regions where energy service outage of the DSO entity occurs,
a time by when the DSO entity expects restoration of distribution services for the MNO entity,
a time when the DSO entity restored energy transmission service and starts expecting rapid intervention by the MNO entity,
a time duration for which the DSO entity expects to require the rapid intervention by the MNO entity for being able to use smart energy services to restore the energy distribution services,
second information of locations where DSO substations need to restore distribution services on priority,
a time at which the MNO device (100) provide the rapid intervention to the DSO entity,
a time duration for which the MNO device (100) provide the rapid intervention to the DSO entity,
third information of locations where the MNO device (100) provides the rapid intervention to the DSO entity,
a time stamp at which the energy distribution services from the DSO entity are restored, and
fourth information of locations where distribution energy service from the DSO substations restored.

7. The DSO entity of claim 5, wherein the at least one processor is configured to:
create a second create MOI request including a plurality of notification subscription parameters for the DSO entity,
transmit, to the MNO entity, the second create MOI request for creating a notification subscription control IOC as per the plurality of notification subscription parameters, and
receive, from the MNO entity, a second create MOI response after creation of the notification subscription control IOC by the MNO entity.

8. The DSO entity of claim 7, wherein the at least one processor is configured to receive a notification based on the notification subscription control IOC informing about the changes to the plurality of information attributes in the outage and rapid recovery IOC.

9. A method performed by a mobile network operation (MNO) entity for coordinated service recovery in a wireless communication system, the method comprising:
receiving, from a distribution system operator (DSO) entity, a first create managed object instance (MOI) request for creating an information object class (IOC), wherein the create MOI request includes a plurality of information attributes for outage and rapid recovery;
creating the IOC for the outage and rapid recovery of the DSO entity based on the plurality of information attributes received from the DSO entity; and
transmitting, to the DSO entity, a first create MOI response after creation of the IOC.

10. The method of claim 9, wherein the plurality of information attributes includes at least one of:
a time stamp of an outage of energy distribution service of the DSO entity,
first information of regions where energy service outage of the DSO entity occurs,
a time by when the DSO entity expects restoration of distribution services for the MNO entity,
a time when the DSO entity restored energy transmission service and starts expecting rapid intervention by the MNO entity,
a time duration for which the DSO entity expects to require the rapid intervention by the MNO entity for being able to use smart energy services to restore the energy distribution services,
second information of locations where DSO substations need to restore distribution services on priority,
a time at which the MNO entity provide the rapid intervention to the DSO entity,
a time duration for which the MNO entity provide the rapid intervention to the DSO entity,
third information of regions where the MNO entity provides the rapid intervention to the DSO entity,
a time stamp at which the energy distribution services from the DSO entity are restored, and
fourth information of regions where distribution energy service from the DSO substations restored.

11. The method of claim 9, further comprising:
receiving, from the DSO entity, a second create MOI request for creation of a notification subscription control IOC to the MNO entity, wherein the second create MOI request includes a plurality of notification subscription parameters;
creating the notification subscription control IOC based on the plurality of notification subscription parameters; and
transmitting, to the DSO entity, a second create MOI response after creation of the notification subscription control IOC.

12. The method of claim 11, further comprising:
detecting changes to the plurality of information attributes for outage and rapid recovery IOC; and
transmitting, to the DSO entity, a notification informing about the changes to the plurality of information attributes based on the notification subscription control IOC.

13. A method of a distribution system operator (DSO) entity for coordinated service recovery in a wireless communication system, the method comprising:
creating a first create managed object instance (MOI) request including a plurality of information attributes for outage and rapid recovery;
transmitting, to a mobile network operation (MNO) entity, the first create MOI request for creating an information object class (IOC) based on the plurality of information attributes for outage and rapid recovery; and
receiving, from the MNO entity, a first create MOI response after creation of the IOC by the MNO entity.

14. The method of claim 13, wherein the plurality of information attributes includes at least one of:
a time stamp of an outage of energy distribution service of the DSO entity,
first information of regions where energy service outage of the DSO entity occurs, a time by when the DSO entity expects restoration of distribution services for the MNO entity,
a time when the DSO entity restored energy transmission service and starts expecting rapid intervention by the MNO entity,
a time duration for which the DSO entity expects to require the rapid intervention by the MNO entity for being able to use smart energy services to restore the energy distribution services,
second information of locations where DSO substations need to restore distribution services on priority,
a time at which the MNO device (100) provide the rapid intervention to the DSO entity,
a time duration for which the MNO device (100) provide the rapid intervention to the DSO entity,
third information of locations where the MNO device (100) provides the rapid intervention to the DSO entity,
a time stamp at which the energy distribution services from the DSO entity are restored, and
fourth information of locations where distribution energy service from the DSO substations restored.

15. The method of claim 12, further comprising:
creating a second create MOI request including a plurality of notification subscription parameters for the DSO entity;
transmitting, to the MNO entity, the second create MOI request for creating a notification subscription control IOC as per the plurality of notification subscription parameters; and
receiving, from the MNO entity, a second create MOI response after creation of the notification subscription control IOC by the MNO entity.

16. The method of claim 15, further comprising:
receiving a notification based on the notification subscription control IOC informing about the changes to the plurality of information attributes in the outage and rapid recovery IOC.

17. The method of claim 13, wherein the first information is determined based on an identifier identifying an MNO facility using DSO energy services.

18. The MNO entity of the claim 1, wherein the first information is determined based on an identifier identifying an MNO facility using DSO energy services.

19. The DSO entity of the claim 5, wherein the first information is determined based on an identifier identifying an MNO facility using DSO energy services.

20. The method of the claim 9, wherein the first information is determined based on an identifier identifying an MNO facility using DSO energy services.
